(19) United States
(12) Patent Application Publication
(10) Pub. No.: US 2003/0018726 A1
(43) Pub. Date: Jan. 23, 2003

(54) Instant messaging

(76) Inventors: Sydney Gordon Low, Kew (AU); Geoffrey Michael Wilson, Wantirna (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/136,022

(22) Filed: Apr. 29, 2002

(30) Foreign Application Priority Data
Apr. 27, 2001 (AU) PR4599/01

(51) Int. Cl. G06F 15/16

(52) U.S. Cl. 709/206; 709/224; 709/207

(57) ABSTRACT

An instant messaging process executed in a communications network, including: receiving message data according to an IM or wireless device messaging protocols; maintaining state data for a user on the basis of the message data; determining a destination one of the protocols on the basis of the state data; and sending the message data according to the destination protocol. The state data includes presence data and protocol data for buddys of the user. The process is executed by an IM gateway of an Internet Service Provider that provides a WAP and SMS portal for mobile telephones in addition to multiple IM protocol support.

### BACKGROUND OF THE INVENTION

1. Field of the Invention

The present invention relates to instant messaging on communications networks.

2. Description of the Related Technology

Instant messaging (IM) allows individuals to monitor the presence of their friends and colleagues on an IM system of the Internet, and to exchange messages and files with those friends and colleagues. To use IM, a user of the Internet executes an IM client on their computer system. The client allows the user to specify a personal identifier, often referred to as a screen name or nickname, by which the user is known to the IM system. The IM client also allows the user to specify a list of known identifiers for other users of the IM system, often known as a buddy list. When the IM client begins execution, it sends a message to an IM server on the Internet, informing it of the user's availability, or presence, for IM purposes, and querying the IM server as to whether the users in the buddy list are also present, that is, whether they are connected to the Internet, have a compatible IM client executing on their computer, and have designated themselves as present to the IM client. The IM server maintains a list of registered identifiers for the users of the IM system. When it receives the login and buddy list messages from the user's client, the IM server flags the user's identifier as being in a present state, and looks up the buddy list nicknames to determine whether they are also in a present state. The server returns a response to the user's IM client, indicating which members of the buddy list are present. On the basis of this information, the user's IM client provides a visual indication of the presence of individual members of the user's buddy list. The user may exchange quasi real-time, ‘instant’ messages with other users who are present on the IM system.

One of the problems with IM is that there are actually several independent IM systems, each using a different protocol and set of servers, and effectively defining a virtual IM network for that particular protocol. For example, AOL Instant Messenger (AIM), Yahoo! Messenger, MSN Messenger, and ICQ are some of the better known IM systems. These systems are not compatible to the extent that, for example, an AIM client can only communicate with clients using an AIM protocol. Thus a user may need to use several different IM clients simultaneously in order to keep in touch with all of their friends. It is desired, therefore, to provide a method and system for alleviating the above, or at least provide a useful alternative.

### SUMMARY OF CERTAIN INVENTIVE ASPECTS

In accordance with one aspect of the present invention there is provided an instant messaging (IM) process executed by a gateway in a communications network, including: sending first IM traffic from IM clients to respective IM servers of the clients; and sending second IM traffic from an IM client using one protocol to an IM client using a different protocol.

Another aspect of the present invention also provides a process for instant messaging (IM) in a communications network, including: receiving IM traffic from IM clients using different IM protocols; and compiling data on the state of said IM clients.

Yet another aspect of the present invention also provides an instant messaging process, including: receiving a message indicating whether a device is connected to a wireless network; and maintaining instant messaging state information for said device in response to said message.

One other aspect of the present invention also provides instant messaging (IM) process including: receiving IM traffic from a first IM client using a first IM protocol; and sending said IM traffic to a second IM client using a second IM protocol.

Another aspect of the present invention also provides a process for instant messaging, including: receiving instant messaging data in a first one of a plurality of instant messaging protocols; and translating said data in accordance with a second one of said plurality of instant messaging protocols.

Yet another aspect of the present invention also provides an instant messaging process, including: receiving instant messaging data in a first instant messaging protocol, said data identifying at least one instant messaging user; for each of said at least one user, identifying an instant messaging protocol, and removing data for said user if said protocol differs from said first instant messaging protocol; and forwarding the remaining instant messaging data.

One other aspect of the present invention also provides an instant messaging process, including: receiving instant messaging data in a first instant messaging protocol, said data including an identifier of a destination instant messaging user; determining a destination instant messaging protocol based on said identifier; translating said instant messaging data in accordance with said destination instant messaging protocol; and sending said translated instant messaging data to said user.

Another aspect of the present invention also provides an instant messaging process, including maintaining a list of instant messaging users and corresponding instant messaging protocols.

Yet another aspect of the present invention also provides a process for instant messaging using a wireless device, including: receiving messaging data from a wireless device; translating said messaging data into a destination instant messaging protocol; and forwarding said instant messaging data to an instant messaging application corresponding to said destination instant messaging protocol.

One other aspect of the present invention also provides a process for instant messaging in a communications network, including: receiving a packet of data in said network, said packet having a destination address; translating instant messaging data in said packet from a first instant messaging protocol to a second instant messaging protocol; and forwarding said translated data to said destination address.

Another aspect of the present invention also provides a process for instant messaging in a communications network, including: identifying data on said network as comprising instant messaging data; redirecting said data to an instant messaging translation server; translating said data from a first instant messaging protocol to a second instant messaging protocol; and forwarding said translated data to an instant messaging application corresponding to said second instant messaging protocol.

Yet another aspect of the present invention also provides an instant messaging process executed in a communications network, receiving message data according to one of a plurality of IM or wireless device messaging protocols; maintaining state data for a user on the basis of said message data; determining a destination one of said protocols on the basis of said state data; sending said message data according to said destination protocol.

One other aspect of the present invention also provides an instant messaging system or software code for executing any one of the above processes.

### BRIEF DESCRIPTION OF THE DRAWINGS

A preferred embodiment of the present invention is hereinafter described, by way of example only, with reference to the accompanying drawings, wherein:

FIG. 1 is a diagram of a preferred embodiment of an IM gateway within a network access system;

FIG. 2 is a flow diagram showing a packet switching process executed by the gateway;

FIG. 3 is a flow diagram showing an IM gateway process executed by the gateway;

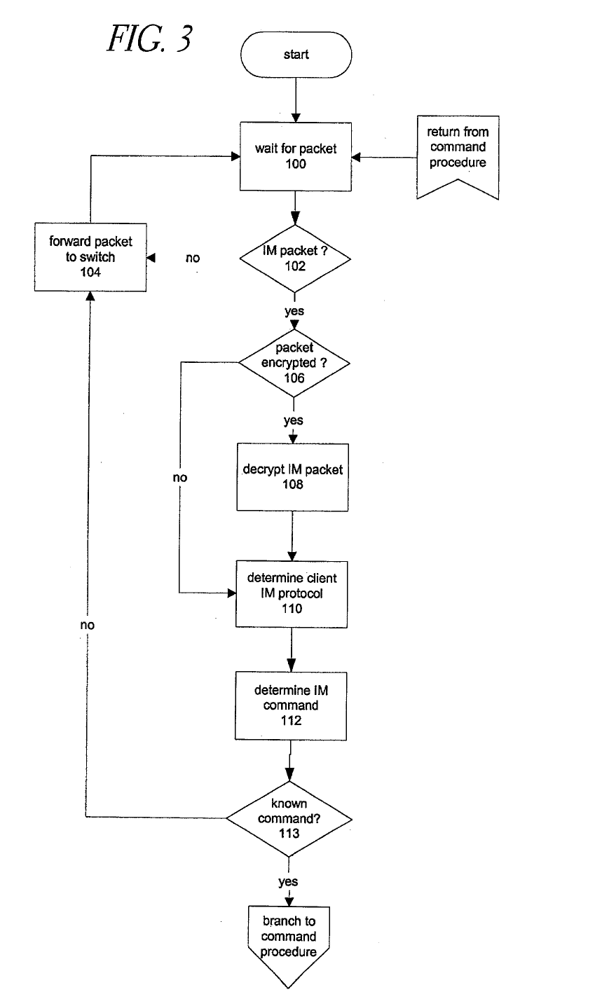

FIG. 4 is a flow diagram showing an IM state change process executed by the gateway;

FIG. 5 is a flow diagram showing an IM contact list process executed by the gateway;

FIG. 6 is a flow diagram showing an IM message translation process executed by the gateway; and

FIGS. 7 to 9 are illustrations of an instant messaging interface on the screen of a wireless device.

### DETAILED DESCRIPTION OF CERTAIN INVENTIVE EMBODIMENTS

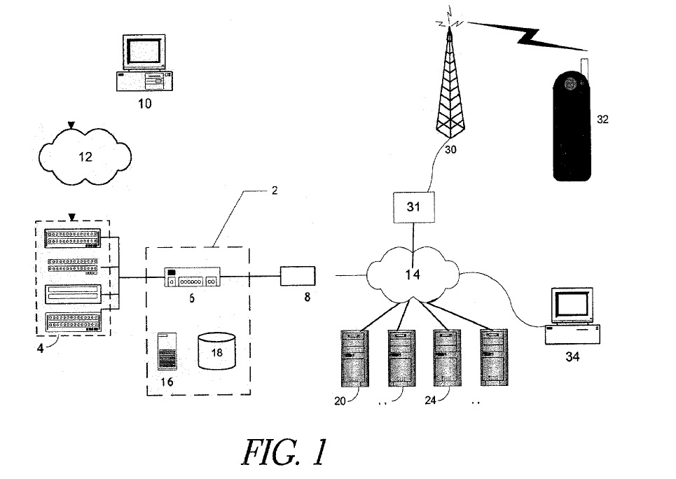

An instant messaging (IM) gateway 2, as shown in FIG. 1, includes a network packet switch 6, a server 16, and a database 18. The packet switch 6 may be an Ethernet packet switch such as the Alteon ACEdirector® Ethernet web switch from Norton Networks Limited, providing packet switching at network layers 2, 3 and 4-7. The server 16 may be a standard computer such as an Intel®-based personal computer, but is preferably a high-performance network server such as a Sun Enterprise® 10000 from Sun Microsystems®). The database 18 is preferably a structured query language (SQL) database such as an Oracle® or MySQL database. The IM gateway 2 is connected to a communications network 14 such as the Internet, and is connected between IM clients and IM servers 20 to 26 on the network 14. Moreover, the IM gateway 2 may advantageously be part of a network access system operated by an Internet Service Provider (ISP), as shown in FIG. 1. The network access system may also include a random access server (RAS) 4, and a router 8 for interfacing to a fiber optical connection to the network backbone. The access system may be as described in the specification of International Patent Application No. PCT/AU00/00418.

Network packets flowing between users dialed into the ISP access system and the network 14 pass through the gateway 2. However, the switch 6 redirects network packets containing IM data in any of the IM protocols known to the server 16, which may be all known IM protocols. The server 16 executes an IM gateway process that records the state or presence of IM users using any of the known IM protocols. The IM gateway process may further translate IM data in any one of the known IM protocols into any one of the other of the known IM protocols, allowing IM users using one IM system to communicate with IM users using another IM system, without requiring the users to use special clients that are able to handle all of the known protocols. Data translated by the server 16 is sent back to the switch 6, which then forwards it to the appropriate destination. For example, an IM message sent from the computer 10 of a user dialed in to the ISP's access system will be redirected by the switch 6 to the server 16. The server 16 processes the message, and sends it back to the switch 6, where it may be forwarded to the network 14, such as to another user's computer 34, or one of several IM servers 20 to 26.

The IM gateway 2 processes the IM packets received from different IM clients in order to allow them to communicate with one another, notwithstanding the fact that they use a different IM protocol. For this to occur, the gateway 2 acts as an IM server between “non-native” IM clients, ie clients who use a different IM protocol. For example, when a user of the AIM client wishes to communicate with a user of the ICQ client, this IM traffic is handled by the gateway 2 without messages being sent back to the native AIM server or the native ICQ server of the respective clients. Messaging traffic between users of the AIM client is sent unaltered by the gateway 2 to a native AIM server, and this is the same for IM traffic between users of the same IM client in that the messaging traffic is passed back to the native servers or clients unaltered. Accordingly the gateway 2 can operate such that the native IM servers, eg the AIM and Yahoo servers, are not aware of the presence of the gateway 2. The gateway 2 processes the IM packets it receives from the clients 10, 34 so as to maintain tables on the state of the clients and lists of IM users (ie contacts such as “buddys”) for each client or user. Placing the gateway 2 in the network path, between an IM client and an IM server or another client, allows it to maintain information of the presence of IM users with different IM clients.

The IM gateway 2 thus allows a user connected to the gateway 2 to communicate with other users using known IM protocols, even though the users may be using incompatible IM clients with different IM protocols. Moreover, the gateway 2 supports its own IM system for users of wireless devices such as mobile telephones and personal data assistants (PDAs). This allows IM users to become part of a virtual, protocol-independent IM network.

It will be appreciated by the skilled addressee that the processes executed by the IN gateway 2 could be executed in a distributed manner by any number of devices, and that at least part of the processes could be executed by hardware circuits such as application-specific application circuits (ASICs). The description below, however, describes processes that are executed by software code stored on the gateway 2.

The server 16 executes a mobile instant messaging process with hypertext markup language (HTML), wireless markup language (WML), and short message service (SMS) interfaces, thus providing access to instant messaging services to users without requiring an IM client to be installed on the user's computing device. In particular, the WML and SMS interfaces support mobile wireless clients. For example, a WML deck may be served to a WAP client such as a WAP browser executing on a mobile device 32 such as a telephone by a web server process that may also execute on the server 16. This allows a user of the mobile telephone 32 to join the protocol-independent virtual IM network, and to exchange messages with other IM users, irrespective of which particular IM client or IM protocol they are using. The gateway 2 therefore acts as a WAP gateway and a SMS portal.

The gateway 2 receives state information from equipment 31 of a mobile communications network 30, indicating whether the device 32 is connected to the mobile network 30. This allows the gateway 2 to store IM state information indicating whether the device 32 is available for receiving IM messages, even if the user of the device has not logged into the IM system using the mobile instant messaging process. For example, if the device 32 is turned on and connected to the network 30, an IM user may request a chat session with the user of the device 32. In response, the gateway 2 sends the request to the device 32. If the device 32 is not logged into the IM system, the request is sent as an SMS message. Similarly, instant messages directed to the device 32 may be sent as SMS messages. If the user replies to the SMS message, the reply is sent back as an instant message to the user that sent the original instant message, via the gateway 2. However, in order to enter an interactive chat session, the user of the device 32 logs into the WAP gateway 2. When the device 32 is disconnected from the network 30, the wireless network equipment 31 informs the gateway 2. Presence messages may be sent to other IM users when the mobile device is connected and disconnected. This provides a transparent IM system for users of mobile devices, and does not require them to login to an IM system in order to receive IM alerts and messages and reply to instant messages.

In practice the IM data held by the gateway 2 may be sent to a master IM gateway 2 of a number of IM gateways 2 of the network 14 that are arranged in a hierarchical structure so as maintain a complete list of the IM data, particularly the presence data, for all IM users. Another alternative is to pass the IM data between the gateways 2 on a peer to peer basis. The mobile IM process and the WAP and SMS functionality may be executed only on the master gateway that acts as a WAP and SMS gateway or portal that connects to one or more network equipment 31 and to the IM gateways 2

A user may connect to the Internet 14 by dialing into the access system of FIG. 1 through the public switched telephone network (PSTN) 12 using a computer 10 with a built-in modem. An IM client may then be executed on the user's computer 10 in order to monitor the availability, or presence, of other users listed in the IM client's buddy list, and to exchange messages with those users, if present. The IM client may be any one of a number of known IM clients, including AOL Instant Messenger (AIM), Yahoo! Messenger, MSN Messenger, ICQ, Bantu, Jabber, Everybuddy and Pow Wow. The protocols used by these clients are documented on the Internet at a number of locations, including http://www.cs.berkeley.edu/˜mikechen/im/protocols, http://cvsweb.jabber.org, and http://www.zigamorph.net/faim/protocol.

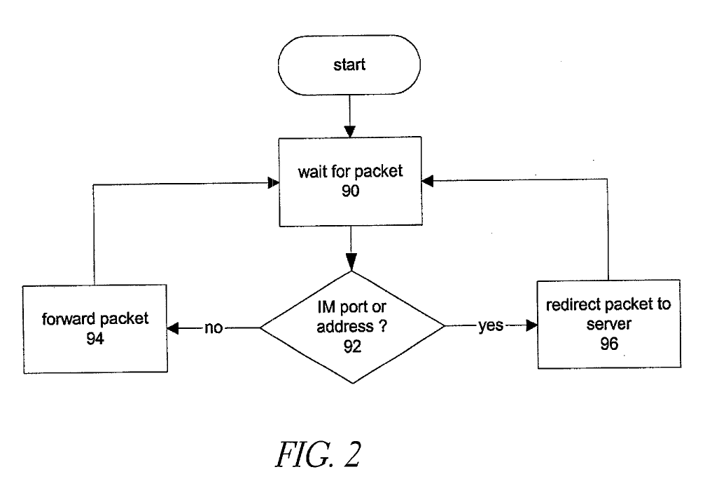

IM services provide centralised servers for maintaining a list of registered users and their states. For example, the network of FIG. 1 includes four IM servers 20 to 26. When the user first starts an IM client executing on the computer 10, the client sends a login message directed to a corresponding IM server on the Internet 14 in order to signal the presence of the user on the corresponding IM network. For example, if the IM client is AIM, the AIM client sends a login command message in an AIM protocol, for example, the OSCAR protocol, directed to an AIM authentication server 20 to login to AIM and thereby record the user's presence on the virtual AIM network. The OSCAR protocol data is sent in a TCP packet from the user's computer 10 directed to the AIM server 20. However, because network packets sent from the computer 10 to the server 20 pass through the gateway 2, these packets are first received at an input port of the switch 6. The switch 6 executes a packet switching process on this port, as shown in FIG. 2. The switch waits for a data packet on the port at step 90. When a packet is received, the switch 6 inspects the packet header at step 92 to determine whether it is directed to either (a) a known IM port number, or (b) an IP address known to the switch as being assigned to one of the IM servers 20 to 26. If no match is found, then the packet is simply forwarded through the switch 6 to the Internet at step 94. Otherwise, the switch 6 redirects the data packets to the IM server 16 at step 96. For example, if the switch 6 determines that the destination address in the packet header matches the IP address of the AIM server 20, then the switch 6 redirects the packet to a port of the server 16. This port is monitored by an IM gateway process, as shown in FIG. 2.

The IM gateway process shown in FIG. 2 is a simplified process. Unfortunately, there are significant differences between the different IM protocols which necessitate different handling procedures. For example, the AIM client maintains a TCP connection to the authentication server 20, whereas other protocols may send UDP packets, or a combination of UDP and TCP packets. The gateway 2 terminates a TCP connection from an IM client and opens a corresponding TCP connection to the intended destination. The client and the server are unaware that their TCP connection actually terminates at the server 16. Furthermore, AIM's OSCAR protocol may send multiple IM commands in a single TCP packet, or one IM command split over multiple TCP packets. Furthermore, AIM uses separate servers for IM services in addition to the authorisation server, including a BOS (basic OSCAR services) server, a chat server, an advertising server, and so on. The simplified flow diagrams also do not show low level details such as packet transmission loops, acknowledgement packets, and KEEP_ALIVE packets which may be sent to maintain IM sessions. For clarity, such details, known to the skilled addressee have been omitted.

The IM gateway process listens on the IM gateway port of the server 16 at step 100. When a redirected packet arrives from the switch 6, it is checked at step 102 to ensure that it contains data in one of the known IM protocols. If not, then it is forwarded to a port of the switch at step 104. Otherwise, the packet is checked to determine whether the packet is encrypted at step 106. IM packets may or may not be encrypted, depending upon which IM protocol is used and also the source and destination of the packet. For example, on the ICQ network, packets sent from an ICQ client to an ICQ server are encrypted, but packets send from the server back to the client are not encrypted. Packets sent from an ICQ client to another ICQ client are also encrypted. If the received packet is encrypted, it is decrypted at step 108. The packets are analysed at step 110 to determine the IM protocol of the packet. Once the IM protocol of the packet is known, the IM command can be determined at step 112. For example, the first packet sent by the IM client will be a login packet. If the command is a command that is not handled by the gateway 2 (step 113), then the original packet is forwarded back to the switch 6 at step 104. Otherwise, the process branches to a subprocess for that command.

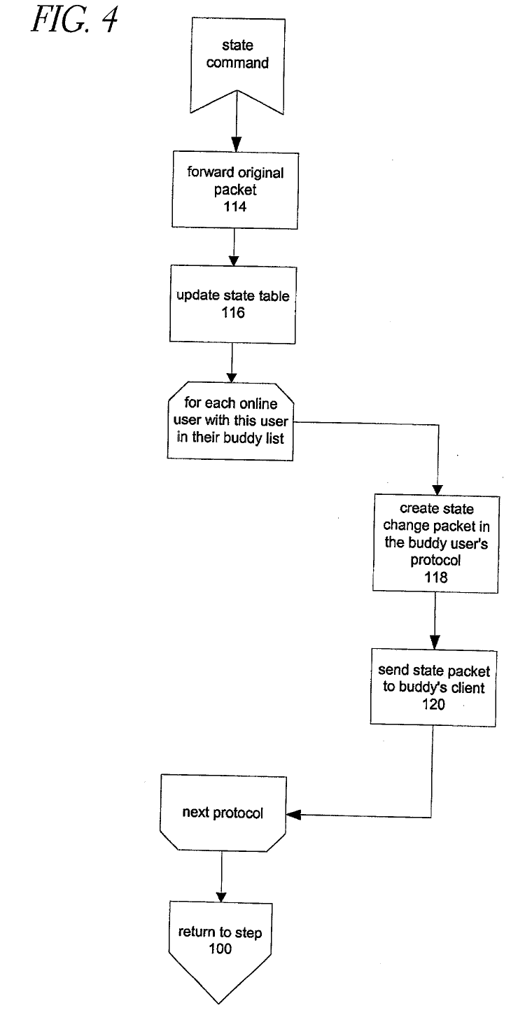

IM clients send a number of commands that change the user's state or presence on the IM network. These include the commands which initiate the user's login to and logout from the IM network, and commands which are sent to indicate that the user is away, idle, or does not wish to be disturbed. These commands are handled by an IM state change process, as shown in FIG. 4. The gateway 2 maintains state tables on the database 18 which includes entries for each IM user connected to an IM network through the gateway 2. As shown in Table 1 below, the database 18 includes a state table for each user of the gateway 2, including the user's screen name, IM protocol, presence state, IP address or mobile telephone number, and a permit/deny mode. The permit/deny mode is used for blocking or permitting messages from other IM users: a value of 1 indicates that the user is permitting all contacts to send instant messages and “see” the user, a value of 2 indicates that the user is denying all contacts, a value of 3 indicates that only contacts in a permit list are permitted to send messages, and a value of 4 indicates that only contacts in a deny list are prohibited from sending messages. These entries are created by the gateway when the user sends state change commands to their native IM system; for example, when a user logs in to their IM system, or changes their state from available to unavailable, and so on. The state table that the gateway 2 maintains is particularly advantageous as it provides an indication of the presence of all of the IM users, e.g., whether an IM user is available or not.

TABLE 1

| UID | screen name | protocol | state | IP address/mobile # | mode |
|---|---|---|---|---|---|
| 0123456 | rab | AIM | online | 128.256.32.2 | 1 |
| 0123457 | fink | MSN | away | 128.256.76.81 | 1 |
| 0123458 | elmo | Yahoo | online | 128.256.43.22 | 1 |
| 8745682 | nos | HTML | online | 128.256.87.24 | 1 |
| 1093278 | syd | GSM | con- | +61 0408 967 522 | 1 |
| | | | nected | | |
| 1099803 | miro | GSM | online | +61 0411 857 937 | 1 |
| 8942084 | smithamat | MSN | offline | | |

A contact table, as shown in Table 2, is used to store a list of an IM user's contacts, including buddies and members of the user's permit list and deny list. The contact table is populated when an IM client sends a buddy list, a permit list, or a deny list to their native IM server. These packets are intercepted by the gateway 2 which analyses them and generates table entries based on data in the lists. The contact table stores information on ‘non-native’ contacts who use an IM protocol different to the protocol used by the IM user, because the native IM server (e.g., an AIM server) will maintain data for native IM contacts, i.e., contacts on the same IM network as the user. Each IM network identifies its users by assigning a unique identifier to each user. As described above, this identifier is generally a character string known as a screen name or nickname. In order for the gateway 2 to identify screen names as designating non-native IM users, these screen names include an identifier of the user's IM network. Unfortunately, AIM screen names are restricted to alphabetic and numeric characters and the space character. For example, the gateway 2 recognises a screen name of “rab AIM” as belonging to an AIM user with the AIM screen name “rab”. However, AIM clients send screen names in a normalised format, in lower case with spaces omitted. Hence an AIM command referring to a screen name “rabaim” is treated as though it was “rab AIM.”

TABLE 2

| UID | buddy name | flags |
|---|---|---|
| 0123456 | smithamat MSN | b |
| 0123456 | elmo Yahoo | bp |
| 0123456 | syd SMS | b |
| 0123456 | david WAP | b |
| 0123456 | james WEB | b |
| 0123457 | fred Yahoo | b |
| 0123458 | rab AIM | b |
| 0123458 | smithamat MSN | b |
| 1093278 | pete SMS | b |
| 1093278 | rab AIM | d |

The contact table also includes flags for each contact indicating whether the contact is a member of the user's buddy, permit, and/or deny lists, indicated by the presence or absence of the first letter of each list name, ie b, p and d. Members of the deny list may not be able to see or send messages to the user, even when the user is otherwise visible (as indicated by the user's state, e.g., online). Similarly, members of the permit list may communicate with the user when the user is otherwise invisible (e.g., the user's state is “away” or DND (do not disturb)). For example, Table 1 indicates that the user with the screen name “elmo” is using Yahoo!. Messenger at a computer with IP address 128.256.43.22, is permitting all users, and has a gateway user id (UID) of 123458. Table 2 indicates that user 0123458 (“elmo”) has two non-native buddies, including “rab” on the AIM network, and “smithamat” on the MSN network. The user “elmo” is on “rab”'s buddy and permit lists, whereas “rab”'s other contacts are only on his buddy list. The user 1093278 (“syd”) has “rab on his deny list. The contact table can be maintained a separate tables for the buddy, permit and deny lists. The manner in which the permit and/or deny lists are used by the gateway 2 for non-native clients may be made consistent with the manner in which the lists are used by the native servers when communicating with the clients.

When the gateway 2 receives a command that will change the user's state, the IM state change forwards a copy of the packet to the switch 6, which sends it to the appropriate IM server at step 114. For example, if the command is an AIM sign_on command to login the user to the AIM network, the command is forwarded to the AIM server 20. If the login was successful, then the state table is updated at step 116 to reflect the user's state as “online” and the IM protocol used by the user. Similarly, if the IM command modifies the user's state to be (un)available, or if the user leaves the IM network, then the table is updated at step 116. This user may be a member of the buddy lists of other users using the gateway 2. The gateway 2 informs these users of their buddy's changed status by forming status packets in the users' protocols at step 118, and sending them to these users at step 120. For example, if the user “elmo” logs out from the Yahoo! IM network, an AIM UPDATE_BUDDY packet will be created at step 118 and sent to the user “rab” at step 120, indicating that buddy “elmo Yahoo” is now offline.

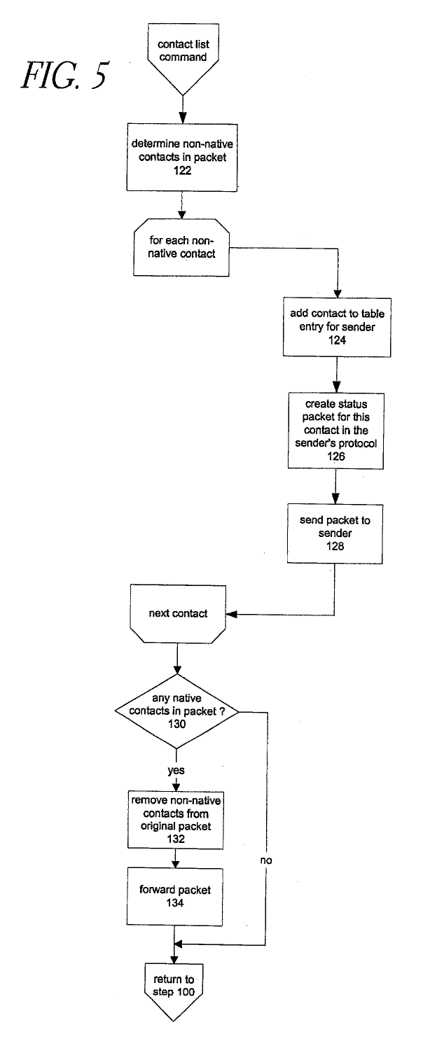

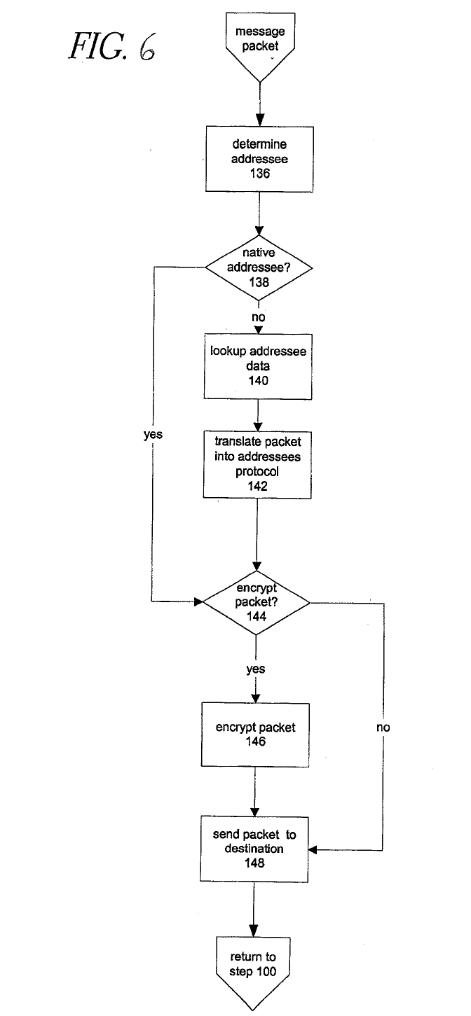

A user's contact lists are updated by contact commands, and are processed according to a contact list process, as shown in FIG. 5. A contact list packet generally contains a list of screen names. These names are checked at step 122 to determine whether they refer to native or non-native users, by matching the end of each screen name with one of the IM network identifiers. For each non-native contact, an entry is added to the contact table at step 124, listing the screen name as a contact for the user. If the contact list packet is a buddy list packet, then the contact is a buddy, and the list of users in the user table is then checked to determine the state of this user. A status packet for this buddy is then created in the user's native protocol at step 126 and is sent to the user at step 128. After all the non-native contacts have been processed, if there are no native contacts in the packet (step 130), then the process completes. Otherwise, the non-native contacts are removed from the packet at step 132, and the packet is forwarded to the native IM server at step 134. If the gateway receives an instant message or chat packet, it is processed by IM message translation process, as shown in FIG. 6. The addressee of the packet is determined at step 136. If the addressee is not a native addressee (step 138), then the addressee's IP address is determined from the user table at step 140. The addressee's state is checked, and the addressee's contact entries are checked to determine that the sender is allowed to send messages to the addressee. If not, then an error message is returned to the sender. Otherwise, the packet is translated into the addressee's IM protocol. If the addressee expects encrypted messages (step 144), then the packet is encrypted at step 146. The message is sent to the addressee at step 148.

As described above, the server 16 also executes a mobile IM process with HTML, WML and SMS interfaces. The mobile IM process may be accessed remotely over the communications network 14, without requiring IM client software to be installed on the user's computer or portable device. This is particularly useful for a user of a wireless device 32, such as a portable telephone, but is also useful for other users of the Internet who may use the HTML interface to access the mobile IM process with a web browser such as Microsoft Internet Explorer®. For mobile users, the device 32 can access the mobile IM process using a wireless application protocol (WAP) or SMS gateway between the Internet and a cellular network 30 such as a GSM or GPRS network. The mobile IM process interfaces with the IM gateway process and is treated by the latter like any known IM client. For example, Table 1 includes table entries for two GSM mobile device users, syd and miro, connected to the gateway system 2. Thus the combination of the mobile IM process and the IM gateway process constitutes a complete IM system in itself, but also provides an interface to any of the known IM systems.

The network equipment 31 contains state information for users of the mobile network 30, indicating whether the users are connected to the mobile network 30, i.e., whether or not their mobile device 32 is turned on and available to receive communications. A user of the mobile device 21 may register with the gateway 2 in order to provide mobile IM services to the mobile user. Once registered, the gateway 2 sends a registration message to the network equipment 31, indicating that the user's mobile network account is registered to use mobile IM services. The network equipment 31 stores an entry for the user, enabling the network equipment 31 to send messages to the gateway 2 whenever the state of the mobile user changes. When the mobile user turns on their mobile device 32 and the device 32 connects to the mobile network 30, this change of state is detected by the network equipment 31. The network equipment 31 performs a lookup on the account associated with the device 32 (e.g., an account associated with a SIM card in the device 32). If the account is registered for mobile IM services, the network equipment 31 sends a message to the gateway 2 indicating that the device 32 is available to receive IM messages. In response, the gateway 2 stores state information for the account in the state table, such as the entry for user “syd” with a state of “connected”. If the user “syd” is recorded as being in other online users' buddy lists on the gateway 2, these users are sent presence information indicating the availability of “syd” on the IM network. If the mobile device 32 is switched off at any time, this is detected by the network equipment 31, which sends a corresponding message to the gateway 2, which updates its state table to indicate that IM messages cannot be sent to the device 32. The gateway 2 then sends presence messages to other IM users, indicating that “syd” is no longer available on the IM network.

Once the user of the device 32 is recorded as having an “connected” state at the gateway 2, users of other IM networks may send IM messages to the mobile user. For example, a user of the computer 10 may wish to send an instant message to the user “syd”, or to start an IM chat session with “syd”. When the gateway 2 receives an IM message for user “syd” from the computer 10, it performs a lookup in the state table and determines that “syd” is in the “connected” state. This state indicates that user syd's device 32 is switched on, but that he is not directly logged on to the mobile IM system. Consequently, the gateway 2 sends an SMS message to the mobile device 32 via an SMS gateway of the mobile network 30. If the message is an instant message, the user of the mobile device 32 may reply to the message which is sent back to the computer 10 via the gateway 2. However, if the message indicates that the IM user of the computer 10 wishes to start a chat session, the user of the mobile device 32 may choose to accept or ignore the invitation. In order to accept, the user directs a micro-browser executing on the mobile device 32 to the mobile IM process on the server 16, and logs in to the IM system of the gateway 2.

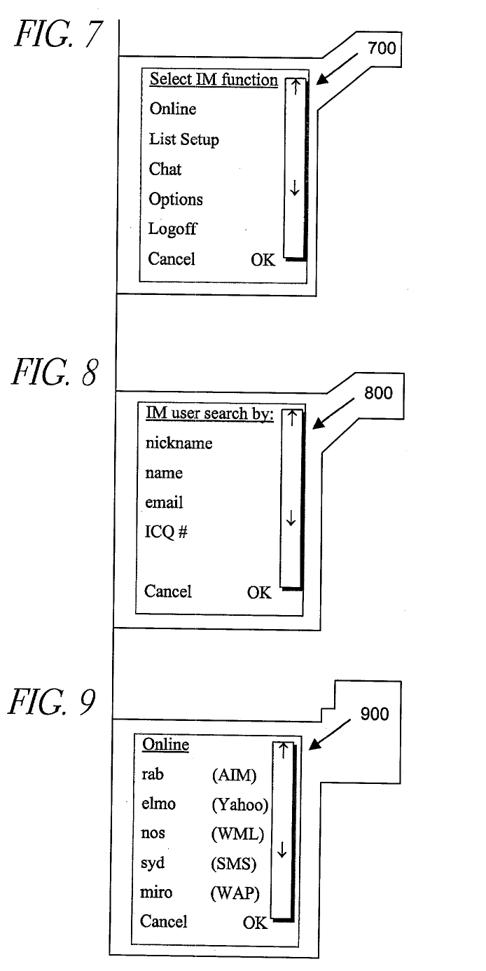

A user of the mobile device 32 is able to access WML decks generated by the mobile IM process to access IM services on the device 32. The WML decks provide cards that are used by the microbrowser of the device 32 to generate displays for selecting IM functions such as logging on and off, developing buddy lists, sending instant messages, and so on. For example, the first card of a deck, as shown in FIG. 7, includes the options of “online”, “list setup”, “chat”, “options” and “logoff”. After the user logs on to the mobile IM service, this is reflected as a state change in the state table of the gateway 2. For example, the state of the user “syd” may be changed from “connected” to “online” when the user logs into the mobile IM service using the mobile IM process. Subsequently, if another IM user wishes to chat with “syd”, the invitation is processed by the gateway 2, which, upon determining that the user “syd” has a state of “online”, may now use WAP rather than SMS to send the invitation. This may be achieved by sending a chat invitation page to the device 32 instead of another deck requested by the device 32. Typically, this request originates from a WML refresh, which is included in every WML deck. For example, if the user has left an online contact display on the screen of the device 32, the invitation will be displayed when the deck is automatically refreshed.

The WML decks provide the usual IM client functions. For example, if the user selects the “Chat” option and then pushes the “OK” button on the telephone 32, the next card 800 is displayed, as shown in FIG. 8, with the options of selecting an IM user by nickname, name, email address or ICQ number. Alternatively, if the user selected the “online” option of the first card 700, the card 900, as shown in FIG. 9, is displayed. The card 900 lists the buddys that are online for the client based on nickname and may also display an indication of the IM Protocol they are using, ie rab (AIM), elmo (YAHOO).

The WML decks also contain embedded WMLScript code to store and retrieve user data from the database 18. This data comprises the IM data that would normally be stored by an IM client executing on a personal computer of a non-mobile user, including the user's preferences, their buddy lists, and the current states of their buddy list members.

The ability to detect when the mobile device 32 is connected or not, and therefore to determine its presence or availability to receive SMS messages is particularly advantageous as it transparently extends instant messaging to include mobile networks without requiring any action on the part of a mobile network user beyond registering for the service. Thus, IM users of the Internet can include mobile network users in their contact lists, in order to monitor their presence on the mobile network, for example. Simple IM functions such as sending an instant message or a chat invitation may be realised by sending SMS messages to the user's mobile device 32 without that user needing to access any IM processes directly. However, more complex IM procedures such as developing contact lists may be performed by accessing the mobile IM process, which constitutes a WAP IM portal.

As described above, the IM gateway process generally determines non-native IM users by their screen names. However, this method does not work for the ICQ IM network, which uses a unique user identification number (UIN) to identify its users. In the case of ICQ, the IM gateway process generates its own set of UINs to use for users of the ICQ network. The IM gateway process performs a lookup function to map between a received UIN and the actual user data, which may be a true UIN for a user of the ICQ network, or a screen name for other IM networks.

Many modifications will be apparent to those skilled in the art without departing from the scope of the present invention as herein described with reference to the accompanying drawings.

What is claimed is:

1. An instant messaging (IM) process executed by a gateway in a communications network, including:
sending first IM traffic from IM clients to respective IM servers of the clients; and
sending second IM traffic from an IM client using one protocol to an IM client using a different protocol.

2. A process for instant messaging (IM) in a communications network, including:
receiving IM traffic from IM clients using different IM protocols; and
compiling data on the state of said IM clients.

3. A process as claimed in claim 2, wherein the state represents whether a user of a client is online or offline.

4. A process as claimed in claim 2, including compiling information on the presence of IM users on the network, regardless of the IM client being used.

5. A process as claimed in claim 2, including compiling a list of contact identifiers for each user of the clients.

6. An instant messaging process, including:
receiving a message indicating whether a device is connected to a wireless network; and
maintaining instant messaging state information for said device in response to said message.

7. A process as claimed in claim 6, including:
receiving an instant message directed to a mobile device;
translating said message for transmission to said device; and
sending said translated message to said mobile device.

8. A process as claimed in claim 7, wherein the translated message is sent using SMS if said device is not logged into an instant messaging system.

9. A process as claimed in claim 7, wherein the translated message is sent using WML if said device is logged into an instant messaging system.

10. An instant messaging (IM) process including:
receiving IM traffic from a first IM client using a first IM protocol; and
sending said IM traffic to a second IM client using a second IM protocol.

11. A process as claimed in claim 10, wherein the second IM client has an interface to a communications protocol of a mobile communications network.

12. A process as claimed in claim 11, wherein the communications protocol is WAP.

13. A process as claimed in claim 11, wherein the communications protocol is SMS.

14. A process for instant messaging, including:
receiving instant messaging data in a first one of a plurality of instant messaging protocols; and
translating said data in accordance with a second one of said plurality of instant messaging protocols.

15. A process as claimed in claim 14, including forwarding said translated data.

16. A process as claimed in claim 15, including:
identifying a user identifier of said instant messaging data; and
determining said second instant messaging protocol based on said user identifier.

17. A process as claimed in claim 16, wherein said determining is also based on said first instant messaging protocol.

18. A process as claimed in claim 17, including determining a destination user identifier corresponding to said second instant messaging protocol.

19. A process as claimed in claim 15, wherein said instant messaging data is sent from a first instant messaging application, and said forwarding includes forwarding translated data to an instant messaging application corresponding to said translated data.

20. A process as claimed in claim 19, wherein said instant messaging application is an instant messaging client.

21. A process as claimed in claim 14, including maintaining user identification and state data for at least one instant messaging protocol.

22. A process as claimed in claim 14, wherein said translating includes replacing user identification data in said instant messaging data with data identifying a user of said second instant messaging protocol.

23. A process as claimed in claim 14, including translating said instant messaging data into a format for transmission to a wireless device.

24. A process as claimed in claim 23, wherein said format is WML.

25. A process as claimed in claim 23, wherein said format is SMS.

26. A process as claimed in claim 14, including storing instant messaging client data on a server.

27. An instant messaging process, including:
receiving instant messaging data in a first instant messaging protocol, said data identifying at least one instant messaging user;
for each of said at least one user, identifying an instant messaging protocol, and removing data for said user if said protocol differs from said first instant messaging protocol; and
forwarding the remaining instant messaging data.

28. A process as claimed in claim 27, including storing data for said user if said protocol differs from said first instant messaging protocol.

29. An instant messaging process, including:
receiving instant messaging, data in a first instant messaging protocol, said data including an identifier of a destination instant messaging user;
determining a destination instant messaging protocol based on said identifier;
translating said instant messaging data in accordance with said destination instant messaging protocol; and
sending said translated instant messaging data to said user.

30. An instant messaging process, including maintaining a list of instant messaging users and corresponding instant messaging protocols.

31. A process as claimed in claim 30, including said maintaining state data for said users.

32. A process as claimed in claim 30, including maintaining at least one contact list for users, respectively.

33. A process as claimed in claim 31, including sending, in response to a change in said state data for a first user, instant message data to a second instant messaging user whose contact list includes said first user.

34. A process for instant messaging using a wireless device, including:
receiving messaging data from a wireless device;
translating said messaging data into a destination instant messaging protocol; and
forwarding said instant messaging data to an instant messaging application corresponding to said destination instant messaging protocol.

35. A process for instant messaging in a communications network, including:
receiving a packet of data in said network, said packet having a destination address;
translating instant messaging data in said packet from a first instant messaging protocol to a second instant messaging protocol; and
forwarding said translated data to said destination address.

36. A process for instant messaging in a communications network, including:
identifying data on said network as comprising instant messaging data;
redirecting said data to an instant messaging translation server;
translating said data from a first instant messaging protocol to a second instant messaging protocol; and
forwarding said translated data to an instant messaging application corresponding to said second instant messaging protocol.

37. An instant messaging process executed in a communications network,
receiving message data according to one of a plurality of IM or wireless device messaging protocols;
maintaining state data for a user on the basis of said message data;
determining a destination one of said protocols on the basis of said state data; and
sending said message data according to said destination protocol.

38. A process as claimed in claim 37, wherein said state data includes presence data and protocol data for contacts of said user.

39. An instant messaging system for executing the process claimed in claim 1.

40. An instant messaging system as claimed in claim 39, comprising an IM gateway, and a messaging gateway for wireless devices; and supporting conversion of messages between IM protocols and messaging protocols for said wireless devices.

41. An instant messaging system as claimed in claim 40, wherein said wireless devices include mobile telephones.

42. An instant messaging system as claimed in claim 41, wherein said system is part of an access system of an Internet Service Provider.

43. Software stored on computer readable memory having code for executing the process as claimed in claim 1.
